(19) United States
(12) Patent Application Publication
(10) Pub. No.: US 2011/0262806 A1
(43) Pub. Date: Oct. 27, 2011

(54) BATTERY PARTS HAVING RETAINING AND SEALING FEATURES, AND ASSOCIATED METHODS OF MANUFACTURE AND USE

(75) Inventors: Andrea Balzan, (US); Giuseppe Segreto, Patti (IT); Norman E. Peterson, Wyoming, MN (US)

(73) Assignee: Water Gremlin Company, White Bear Lake, MN (US)

(21) Appl. No.: 13/046,643

(22) Filed: Mar. 11, 2011

Related U.S. Application Data
(60) Provisional application No. 61/313,668, filed on Mar. 12, 2010.

(51) Int. Cl. H01M 2/30; H01M 10/04

(52) U.S. Cl. 429/211; 29/623.1

(57) ABSTRACT

Battery parts, such as battery terminals and bushings providing both top and front access for connection, and associated methods of manufacture and use are described herein. In one embodiment, a battery terminal can include one or more features for interlocking or engaging the adjacent battery container material to prevent or reduce separation between the battery part and the container material and prevent or reduce acid leakage. In one embodiment, the engagement feature can include raised, parallel lips, rims or flanges that extend upwardly along outer edges of a groove or channel formed in a surface of the battery part. The flanges can be deformed by a tool or otherwise so that they bend inwardly toward each other to at least partially close off the opening to the channel. When battery container material flows into the channel and hardens, it forms a bead or elongate bulb that interlocks and engages the battery part.

### APPLICATIONS INCORPORATED BY REFERENCE

The present application claims priority under 35 USC §119(e) to U.S. Provisional Application No. 61/313,668, filed Mar. 12, 2010, the disclosure of which is incorporated herein by reference in its entirety.

### APPLICATIONS INCORPORATED BY REFERENCE

U.S. Patent Application No. 61/174,344, filed Apr. 30, 2009 and entitled “BATTERY PARTS HAVING RETAINING AND SEALING FEATURES AND ASSOCIATED METHODS OF MANUFACTURE AND USE;” U.S. patent application Ser. No. 12/533,413, filed Jul. 31, 2009 and entitled “BATTERY PARTS AND ASSOCIATED SYSTEMS AND METHODS;” and International Application No. PCT/US2008/064161, filed May 19, 2008 and entitled “BATTERY PARTS AND ASSOCIATED METHODS OF MANUFACTURE AND USE;” are incorporated herein in their entireties by reference.

### TECHNICAL FIELD

The following disclosure relates generally to battery parts and, more particularly, to battery terminals, battery terminal bushings, and the like having features for retaining and sealing the battery part in a battery container.

### BACKGROUND

Battery terminals are typically cold formed or cast from lead or lead alloys. In a conventional lead-acid battery for use in, for example, an automobile, the terminals are truncated cone-shaped posts (one positive; one negative) that protrude from a casing or container that carries electrolyte. The shape of the posts can facilitate attachment to a cable clamp or other suitable connector for providing electrical power from the battery to the vehicle. Front access battery terminals for use in, for example, the telecommunications industry typically have a cable attachment feature, such as a threaded socket, lug, etc. accessibly positioned on a front face or sidewall of the battery container.

Battery containers are typically formed from a moldable resin, such as thermoplastic resin, polypropylene, and the like. During manufacture of conventional battery containers or, more specifically, container covers, the uncured resin flows around the base of the terminals and secures the terminals in place once it hardens. After the terminals have been secured in place, a lead anode can be inserted into a hole in the terminal and melted to fill the hole and form a mechanical and electrical connection to a battery grid positioned within the container.

Battery terminals can become loose in the surrounding container material if subjected to repeat or excessive twisting or torsional loads. Additionally, shrinkage of the battery container may also contribute to loosening of the terminals and/or leakage of electrolyte over time. Some battery terminals include annular rings that extend around the base of the terminal to provide an extended interface between the base of the terminal and the adjacent container material. This interface can provide a torturous path or “labyrinth seal” that inhibits or prevents acid or electrolyte from escaping the battery container.

### BRIEF DESCRIPTION OF THE DRAWINGS

FIGS. 1A-1C are a series of side elevation, end, and cross-sectional side elevation views, respectively, of a battery part having a container engagement feature configured in accordance with an embodiment of the disclosure.

FIGS. 2A and 2B are enlarged cross-sectional views of a portion of the battery part of FIGS. 1A-1C, illustrating a method of forming the container engagement feature in accordance with an embodiment of the disclosure.

FIG. 3 is an enlarged cross-sectional view of a portion of the battery part of FIGS. 1A-1C, showing the engagement feature embedded in battery container material in accordance with an embodiment of the disclosure.

FIGS. 4A-4C are a series of top isometric, top, and bottom isometric views, respectively, of another battery part having one or more container engagement features configured in accordance with the present disclosure.

FIG. 5 is an enlarged isometric view of a portion of a battery part having a battery container engagement feature configured in accordance with an embodiment of the disclosure.

FIGS. 6A and 6B are enlarged cross-sectional views illustrating a method of forming a battery container engagement feature on the battery part of FIGS. 4A-4C, in accordance with an embodiment of the disclosure.

FIG. 7A is a top isometric view of a battery assembly having battery terminals with container engagement features configured in accordance with the present disclosure.

FIGS. 8A and 8B are top views of portions of battery parts having container engagement features configured in accordance with additional embodiments of the disclosure.

### DETAILED DESCRIPTION

The following disclosure describes various embodiments of battery parts, such as terminals, bushings, and the like for lead-acid batteries, and associated methods of manufacture and use. In one embodiment, for example, a battery terminal configured in accordance with the present disclosure includes one or more retaining features, such as crimped flanges, that can interlock or engage the container material surrounding the terminal to prevent the material from moving away from the terminal and causing acid leakage. As described in greater detail below, these interlocking or retention features can be formed all the way around a portion of the battery terminal (for example, all the way around the perimeter of a bushing), or only in local areas, such as areas where the tendency for the container material to pull away from the terminal is relatively high.

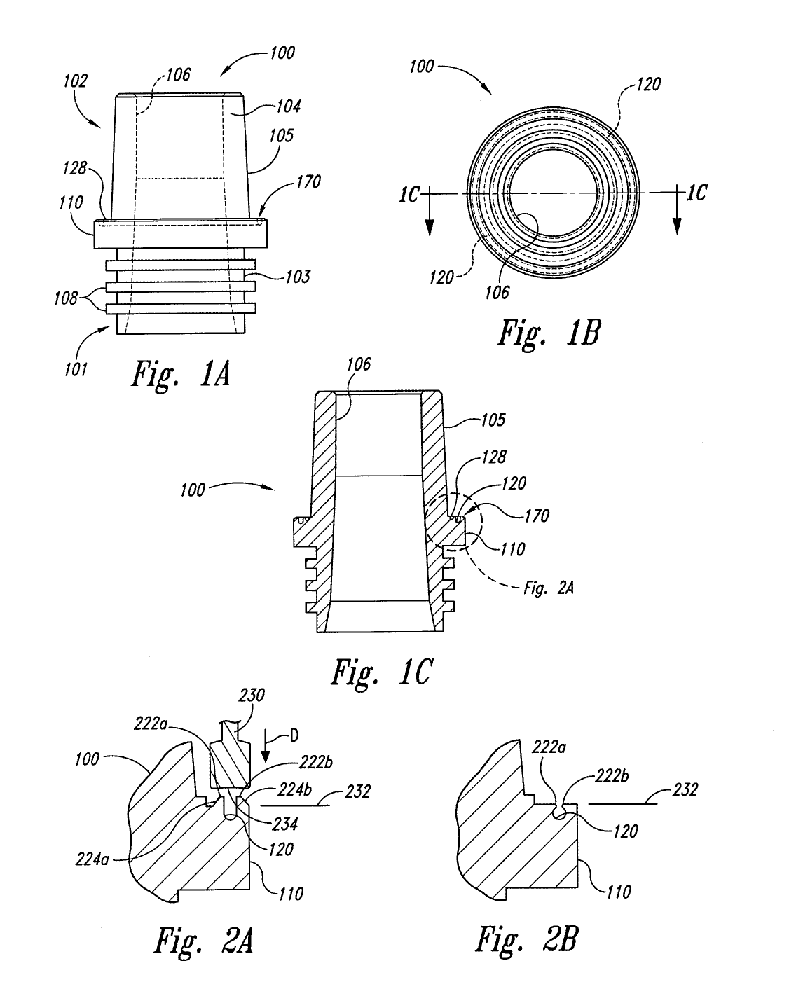

Certain details are set forth in the following description and in FIGS. 1-8B to provide a thorough understanding of various embodiments of the invention. Other details describing well-known structures and systems often associated with batteries and associated battery parts (e.g., lead and/or lead alloy battery parts such as top and front access terminals and bushings, moldable battery containers, etc.), and methods for forming such parts (e.g., forming, casting, injection molding, etc.), are not set forth in the following disclosure to avoid unnecessarily obscuring the description of the various embodiments of the invention.

Many of the details, dimensions, angles and/or other portions shown in the Figures are merely illustrative of particular embodiments of the invention. Accordingly, other embodiments can have other details, dimensions, angles and/or portions without departing from the spirit or scope of the present invention. In addition, further embodiments of the invention may be practiced without several of the details described below, while still other embodiments of the invention may be practiced with additional details and/or portions.

In the Figures, identical reference numbers identify identical or at least generally similar elements. To facilitate the discussion of any particular element, the most significant digit or digits of any reference number refers to the Figure in which that element is first introduced. For example, element 110 is first introduced and discussed with reference to FIG. 1.

FIG. 1A is a side elevation view of a battery part 100 having an engagement feature 170 configured in accordance with an embodiment of the disclosure. FIG. 1B is an end view of the battery part 100, and FIG. 1C is a cross-sectional, side elevation view of the battery part 100 taken substantially along line 1C-1C in FIG. 1B. Referring to FIGS. 1A-1C together, in the illustrated embodiment the battery part 100 is a terminal having a lug portion 104 extending from a base portion 103. The lug portion 104 can have a variety of different shapes known in the art (e.g., a tapered cylindrical shape, truncated cone, etc.) suitable for attachment to a cable clamp or other electrical connector. An annular base flange 110 extends around the battery part 100 between the base portion 103 and the lug portion 104. A passage or through-hole 106 extends through the battery part 100 from a first end portion 101 to a second end portion 102.

The base portion 103 can include one or more sealing rings 108 (e.g., annular acid sealing rings) configured to be embedded in battery container material during formation of the corresponding battery container or container lid (not shown in FIG. 1A). Once the battery is assembled, the sealing rings 108 can form a tortuous path-type seal to inhibit or prevent electrolyte or acid (e.g., sulfuric acid) from escaping from the battery container during use. In other embodiments, battery parts configured in accordance with the present disclosure can include other types of sealing rings and/or other sealing features that extend around, or at least partially around the base portion 103, or one or more of the sealing rings 108 may be omitted. The battery part 100 can be formed from lead, lead alloy, and/or other suitable materials known in the art. Moreover, the battery part 100 can be formed by cold-forming, cold-forming with a segmented mold, hot-forming, role-forming, stamping, etc., as well as by casting (e.g. die casting), forging, machining, and/or other suitable methods known in the art.

In one aspect of this embodiment, the battery part 100 includes an engagement feature 170 formed in the base flange 110. More particularly, in the illustrated embodiment the engagement feature 170 includes an annular channel or groove 120 formed in an upper surface 128 of the base flange 110. The upper surface 128 extends radially outward from the longitudinal axis of the battery part 100 at an angle (e.g., an angle of from about 90 degrees to about 110 degrees) relative to an outer surface 105 of the lug portion 104. Further aspects of the engagement feature 170 are described in greater detail below with reference to FIGS. 2A and 2B.

FIG. 2A is an enlarged cross-sectional view of the base flange 110 taken from FIG. 1C, and FIG. 2B is the same cross-sectional view after the engagement feature 170 has been fully formed. Referring first to FIG. 2A, the engagement feature 170 includes a first raised portion or first flange 224a and a second flange 222b which extend upwardly from each side of the groove 120. Each of the flanges 224 includes an angled or beveled outer surface 224 (identified individually as a first beveled surface 224a and a second beveled surface 224b). The groove 120 and the flanges 222 can be formed by any suitable method known in the art, including casting, cold-forming, stamping, etc.

In the illustrated embodiment, the groove 120 can have a cylindrical or circular bottom surface connecting the opposing sidewalls thereof, but in other embodiments, the groove 120 can have a generally rectangular or flat bottom surface. Moreover, although the groove 120 extends circumferentially around the entire upper surface 128 of the base flange 110, and other embodiments, the groove 120 may only extend for a portion of the distance around the base flange 110, thereby providing one or more localized engagement features as opposed to a continuous engagement feature.

To fully form the engagement feature 170, a tool 230 (e.g., a crimping tool) having a slightly concave forming surface 234 is moved in direction D until the forming surface 234 contacts the opposing groove flanges 222. The tool 230 presses against the flanges 222 until the flanges 222 are essentially pushed flat toward a crimp level 232, which is slightly below the initial height of the flange surface 128. As shown in FIG. 2B, the forming process forces the flanges 222 inwardly toward each other, so that the groove 120 is narrower at the top than at the bottom.

In one embodiment, the tool 230 can be a circular tool having an annular tool surface 234 that extends all the way around the lug portion 104 so that it can simultaneously deform the entire flanges 522 of the engagement feature 170. In other embodiments, this operation can be performed by two or more tools that operate simultaneously, or in series, to deform the flanges 522 over a portion of the engagement feature 170. In yet another embodiment, a moving tool, such as a roller having a suitable profile, can be used to deform the flanges by rolling over the top of the flanges and applying downward pressure. In yet other embodiments, the tool surface 234 can be flat, or can have two generally flat surfaces that angle slightly inward in an inverted “V” shape. The foregoing are just some of the ways that the engagement feature 170 can be formed. Accordingly, in other embodiments the engagement features 170 can be formed using other tools and/or other processes.

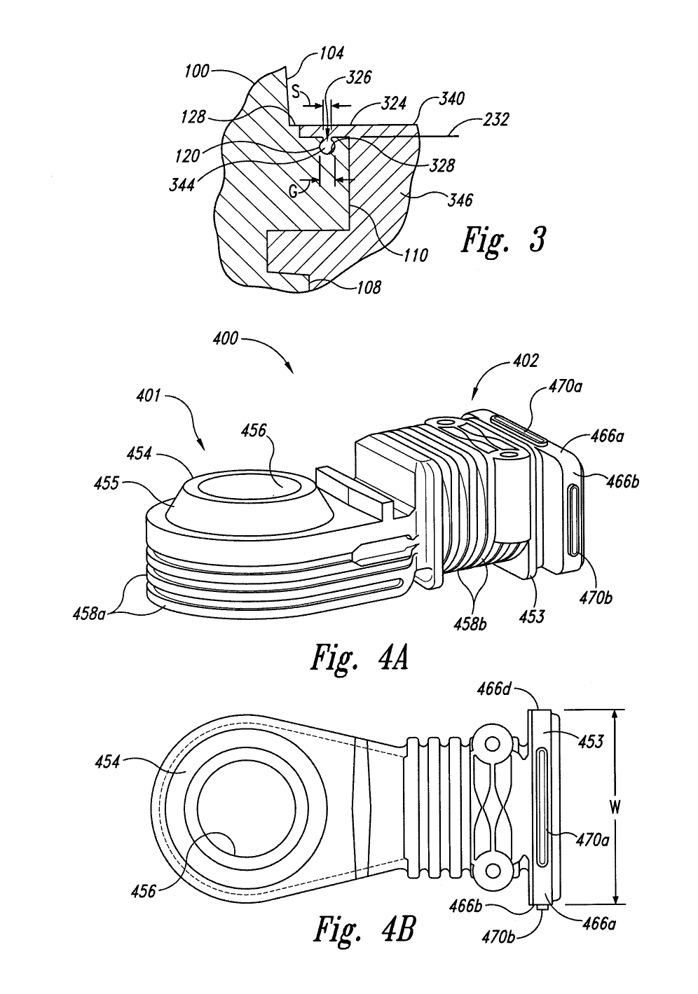

FIG. 3 is an enlarged cross-sectional view showing the base flange 110 embedded in a battery container 340 in accordance with an embodiment of the disclosure. In the illustrated embodiment, the battery part 100 is molded into the battery container 340 so that an upper surface 342 of container material 346 (e.g., plastic material such as polypropylene, etc.) is at least approximately flush with the upper surface 128 of the terminal base flange 110. In this way, the container material 346 encases the base flange 110 and flows into the groove 120 before hardening.

The groove 120 has an opening 326 with a first width S and an interior portion 328 with a second width G. In the illustrated embodiment, the opening width S is narrower than the interior width G. As a result, when the container material 346 hardens in the groove 120, the material 346 forms a bulbous ring or locking feature that engages the groove 120, making it difficult to withdraw the container material from the groove 120 and/or move the container material surrounding the base flange 110. Accordingly, the crimped flanges 222 of the annular groove 120 form an engagement feature that interlocks the container material 346, thereby preventing battery acid from leaking out from around the battery part 100 in use. Conversely, if the battery material 346 tended to pull away from the battery part 100 over time or in use, this could lead to acid leakage around the battery part 100, and/or reduce the ability of the battery part 100 to resist torsion and/or other loads when being connected to a cable clamp or other device.

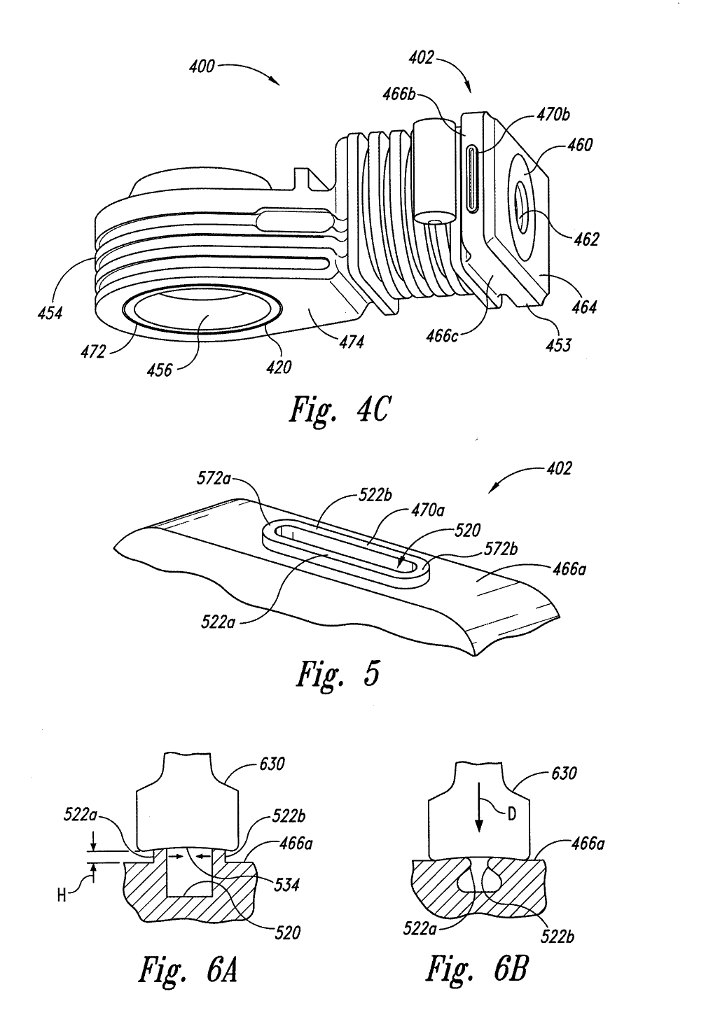

FIGS. 4A-4C are a series of top isometric, top, and bottom isometric views, respectively, of a battery part 400 configured in accordance with another embodiment of the disclosure. Referring to FIGS. 4A-4C together, the battery part 400 includes a connector portion 453 extending laterally from a bushing portion 454. In the illustrated embodiment, the battery part 400 can be a battery terminal that provides side or front access for attaching cables and/or other electrical equipment to the battery. More specifically, as shown in FIG. 4C, the connector portion 453 houses an insert (e.g., a brass insert) having a threaded bore 462 configured to receive a fastener for, e.g., a cable connector.

The bushing portion 454 can include a through-hole 456 centered in a raised boss 455. One or more first sealing rings 458a can extend around the bushing portion 454 in conventional fashion. Similarly, one or more second sealing rings 458b can extend around the outside of the connector portion 453. In the illustrated embodiment, the longitudinal axis of the connector portion 453 (e.g., the central axis of the threaded bore 462) can be oriented at a right angle, or at least generally perpendicular, to the central axis of the through-hole 456 extending through the bushing portion 454. Although one type of front axis or side axis terminal is illustrated in FIGS. 4A-4C, the various container engagement features described herein can be used with a wide variety of different battery parts, including front access terminals having configurations that differ from that illustrated in FIGS. 4A-4C.

As shown in FIG. 4C, a distal end portion 402 of the battery part 400 includes a plurality of side faces 466 (identified individually as side faces 466a-d) extending at generally right angles to an end face 464 that surrounds the threaded insert 460. In the illustrated embodiment, one or more of the side faces 466 can include a corresponding engagement feature 470 (identified individually as engagement features 470a and 470b). As described in greater detail below, the engagement features 470 can be at least generally similar in structure and function to the engagement feature 170 described above with reference to FIGS. 1A-3.

In one embodiment, the battery part 400 can include only the first engagement feature 470a on the first side face 466a. In other embodiments, one of more of the other side faces 466 can include a corresponding engagement feature 470. In a further embodiment, a single engagement feature similar in structure and function to the engagement feature 470a can extend all the way around the distal end portion 402 of the battery part 400 so that it extends along each side face 466 in a continuous track. Accordingly, the present disclosure describes localized engagement or interlocking features as well as annular or otherwise continuous engagement features for fixedly securing battery container material to corresponding battery terminals and/or other parts.

As shown in FIG. 4C, in another aspect of this embodiment, the battery part 400 can further include an annular engagement feature 472 extending around the perimeter of the through-hole 456 on a bushing lower surface 474. The engagement feature 472 can include an annular groove 420 with raised flanges, and can be at least generally similar in structure and function to the engagement feature 170 described above with reference to FIGS. 1A-3. In another embodiment, the battery part 400 can include a similar engagement feature on the opposite side of the bushing portion 454 outboard of the boss 455 (FIG. 4A). As the foregoing illustrates, battery parts configured in accordance with the present disclosure can include engagement features as described herein in virtually any location on the battery part where the container material may have a tendency to pull away from the battery part.

FIG. 5 is an enlarged isometric view of the distal end portion 402 illustrating various aspects of the first engagement feature 470a in more detail. In one aspect of this embodiment, the engagement feature 470a includes opposing raised portions or flanges 522a and 522b spaced apart by a recess, channel or groove 520 extending therebetween. In the illustrated embodiment, the flanges 522 are joined together at corresponding end portions 572 so that the flange portions 522 form a continuous lip or rim around the groove 520 prior to being deformed. In other embodiments, the flanges 522 can remain more or less parallel and simply taper off at the ends rather than join. Accordingly, engagement features configured in accordance with the present disclosure are not limited to the particular embodiment illustrated in FIG. 5.

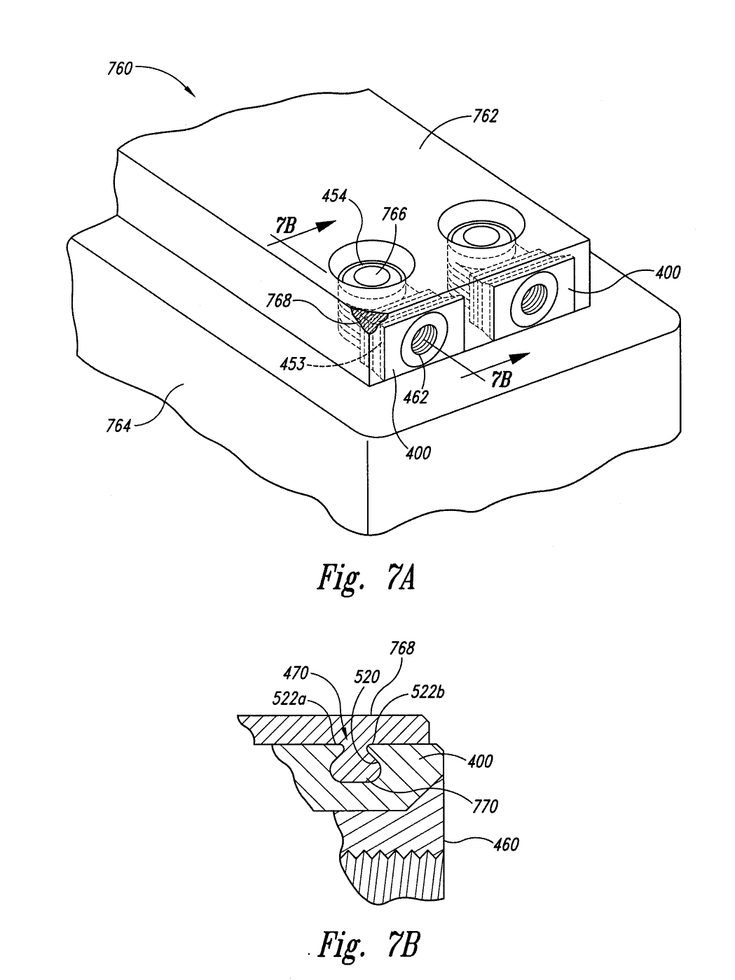

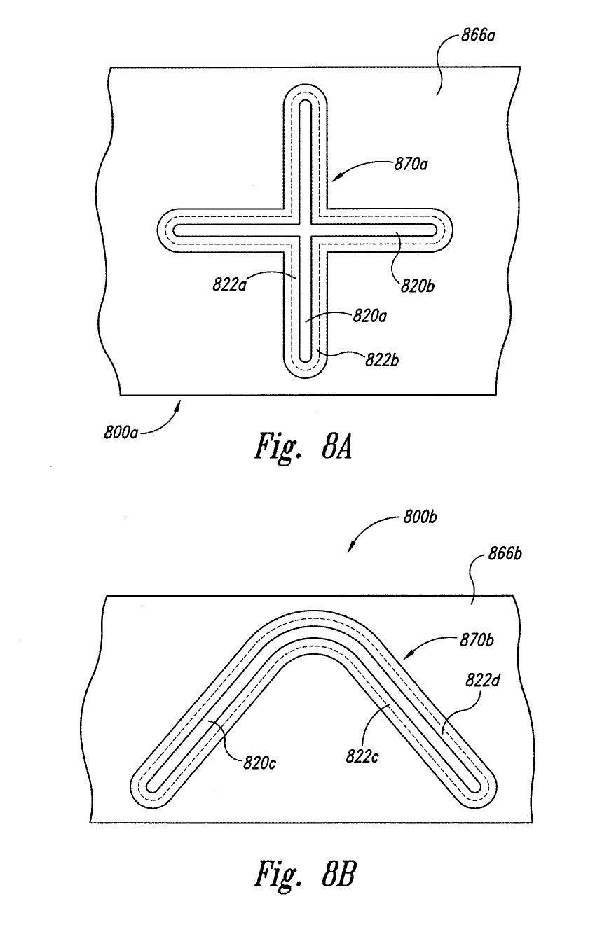

FIGS. 6A and 6B are enlarged, cross-sectional views illustrating a method of deforming the engagement feature 470a prior to molding the battery part 400 into a battery container. In the illustrated embodiment, the flanges 522 protrude a height H above the side face 466a of the distal end portion 402. In one embodiment, the height H can be from about 0.02 inch to about 0.1 inch, or about 0.04 inch to about 0.06 inch. In other embodiments, the flanges 522 can have other heights, widths, shapes, and/or orientations without departing from the spirit or scope of the present disclosure. Moreover, although the flanges 522 of the illustrated embodiment are substantially rectangular with squared-off ends, in other embodiments the flanges 522 can be tapered and/or have angled or beveled outside corners that facilitate forming similar to, for example, the flanges 222 described above with reference to FIGS. 2A and 2B.

To crimp or otherwise deform the flanges 522 prior to embedding the battery part 400 in container material, a tool 630 is moved downwardly in direction D into contact with the opposing flanges 522. The tool 630 can include a slightly concave tool surface 634 that drives the flanges 522 inwardly as the tool 630 moves downwardly. As the tool surface 634 comes into contact with the side face 466a, it drives the flanges 522 inwardly toward each other to close up the opening of the groove 520.

Although one type of tool is illustrated in FIGS. 6A and 6B, in other embodiments, other types of tools can be used to deform the flanges 522 of the engagement feature 470. For example, in other embodiments it is anticipated that the opposing flanges 522 can be individually crimped inward with a single tool. In yet another embodiment, a roller having an appropriate outer contour could be used to deform the flanges 522 by rolling over the flanges with sufficient pressure.

FIG. 7A is a top isometric view of a battery assembly 760 that includes two of the battery parts 400 (as, e.g., a positive and negative terminal), and FIG. 7B is an enlarged cross-sectional view taken substantially along line 7B-7B in FIG. 7A. Referring first to FIG. 7A, the battery parts 400 are fixedly embedded or encased in a battery container cover 762 so that the threaded bores 462 are exposed and accessible to received a threaded fastener for an attachment to a suitable connector (not shown). The battery container cover 762, as well as a mating container body 764, can be formed from a moldable resin or material 768, such as polypropylene, polyethylene, other plastics, thermoplastic resins, and/or other suitable battery container materials known in the art. During manufacture of the container cover 762, molten container material 768 can be flowed around the bushing portions 454 and the connector portions 453 (FIG. 4) of the battery parts 400 so that the side faces 466 of the connector portions 453 are encased in the container material 768. After the container material 768 has hardened to secure the battery parts 400 to the container cover 762, a lead post 466 and/or molten lead or other suitable material can be inserted into the through-hole 456 of the bushing portion 454 to form a mechanical and electrical connection to a battery grid (not shown) within the container body 764.

Referring next to FIG. 7B, this view illustrates how the battery cover material 768 flows down into the groove 520 of the engagement feature 470 during molding. As explained above with reference to FIG. 3, the opening at the top of the groove 520 is narrower than the width of the interior portion. As a result, when the container cover material 768 hardens, it forms an elongate bulb or bead that is locked or otherwise engaged with the battery part 400. In the foregoing manner, the engagement feature 470 helps lock the container material 768 to the battery part 400 and prevent the container material 768 from pulling away from the battery part 400, thereby preventing acid leakage during use of the battery assembly 760.

FIGS. 8A and 8B are top views of portions of battery parts 800a and 800b having engagement features 870a and 870b configured in accordance with additional embodiments of the disclosure. Referring first to FIG. 8A, the engagement feature 870a can be formed at least generally as described above in a surface portion 866a of the battery part 800a. In the illustrated embodiment, however, the engagement 870a includes a first channel or groove 820a and a second channel or groove 820b which form an “X” pattern or cross. Referring next to FIG. 8B, in this embodiment, the engagement feature 870b forms a “V” shape or a “boomerang” shape. As the foregoing illustrates, there are a wide variety of different shapes, sizes, and orientations of locking features having grooves or channels with corresponding deformed flanges as described herein. The particular shape, size and/or location of such engagement features on any particular battery part can be at least partially dictated by the shape of the battery part and/or its position or orientation in the battery container.

The present disclosure describes various embodiments of battery parts, such terminals, bushings, and the like for lead-acid batteries, and associated methods of manufacture and use. In one embodiment, for example, a battery terminal configured in accordance with the present disclosure includes one or more retaining features, such as crimped flanges, that can help prevent acid leakage and interlock or engage the container material surrounding the terminal to prevent the container material from pulling away from the terminal in use. From the foregoing, it will be appreciated that specific embodiments of the invention have been described herein for purposes of illustration, but that various modifications may be made without deviating from the spirit and scope of the various embodiments of the invention. Further, while various advantages associated with certain embodiments of the invention have been described above in the context of those embodiments, other embodiments may also exhibit such advantages, and not all embodiments need necessarily exhibit such advantages to fall within the scope of the invention. Accordingly, the invention is not limited, except as by the appended claims.

1-3. (canceled)

4. A battery terminal configured to be embedded in a battery container, the battery terminal comprising:
a lug portion extending from a base portion;
a flange extending outwardly between the base portion and the lug portion, wherein the flange includes an upper surface that extends radially outward from a longitudinal axis of the battery terminal proximate the lug portion; and
a container material engagement feature on the upper surface of the flange, wherein the container material engagement feature includes a groove positioned between a first flange and a second flange, wherein the first flange and the second flange define an opening to the groove, wherein the opening has a first width and an interior portion of the groove has a second width, greater than the first width.

5. The battery terminal of claim 5 wherein the upper surface extends radially outward from the longitudinal axis of the battery terminal at an angle of from about 90 degrees to about 110 degrees.

6. The battery terminal of claim 4 wherein the container material engagement feature extends around the entire battery terminal.

7. The battery terminal of claim 4 wherein the groove includes a generally cylindrical bottom surface connecting opposing sidewalls.

8. The battery terminal of claim 4 wherein the groove includes a generally flat bottom surface connecting opposing sidewalls.

9. The battery terminal of claim 4, further comprising a through-hole extending through the lug portion and the base portion of the battery terminal.

10. A battery part configured to be embedded in battery container material, the battery part comprising:
a bushing portion having a through-hole; and
a connector portion extending from the bushing portion generally perpendicular to a longitudinal axis of the through-hole, the connector portion including:
means for receiving an electrical connection;
a side surface portion adjacent the means for receiving an electrical connection; and
at least one container material engagement feature positioned on the side surface portion, wherein the container material engagement feature includes opposing flanges defining an opening to a channel, and wherein the flanges extend toward each other and are approximately level with an exterior surface of the side surface portion.

11. The battery part of claim 10 wherein the opposing flanges of the at least one container material engagement feature are joined together to form a continuous rim around the channel.

12. The battery part of claim 11 wherein the side surface portion is a first side surface portion, wherein the battery part includes a plurality of additional side surface portions, and wherein the at least one container material engagement feature comprises a plurality of container material engagement features disposed on the plurality of side surface portions.

13. The battery part of claim 10 wherein the side surface portion is a first side surface portion, wherein the battery part includes a plurality of additional side surface portions, and wherein the at least one container material engagement feature extends around the connector portion, along each of the plurality of side surface portions.

14. The battery part of claim 10 wherein the bushing portion includes an annular container material engagement feature extending continuously around the through-hole on an exterior surface of the bushing portion.

15. The battery part of claim 14 wherein the annular container material engagement feature is a first annular container material engagement feature, the exterior surface is a first exterior surface, and wherein the bushing portion further includes a second annular container material engagement feature extending continuously around the through-hole on a second exterior surface of the bushing portion.

16. The battery part of claim 10 wherein the opening to the channel has a first width, and wherein an interior portion of the channel has a second width, the second width being greater than the first width.

17. The battery part of claim 10 wherein the bushing portion includes a first plurality of sealing rings, and wherein the connector portion further includes a second plurality of sealing rings.

18. The battery part of claim 10 wherein the means for providing an electrical connection includes a threaded bore for receiving a threaded fastener, and wherein the threaded bore extends generally perpendicular to the longitudinal axis of the through-hole.

19. A method for making a battery part, the method comprising:
forming a through-hole in a portion of lead;
forming a surface on the portion of lead that extends radially outward from a longitudinal axis of the through-hole;
forming a pair of opposing flanges on the surface that protrude outwardly from the surface;
forming a groove in the surface between the opposing flanges, the groove having a first width; and
pressing the opposing flanges toward the surface and toward each other to form an opening to the groove having a second width, less than the first width.

20. The method of claim 19 wherein forming a through-hole in a portion of lead includes forming a through-hole in a battery terminal, and wherein forming the pair of opposing flanges and forming the groove includes forming the pair of opposing flanges and forming the groove around the entire battery terminal.

21. The method of claim 19, further comprising embedding the battery part in a battery container by flowing liquid container material over the groove.

22. The method of claim 19 wherein forming a pair of opposing flanges that protrude above the surface includes forming the pair of opposing flanges with beveled outer surfaces.

23. The method of claim 22 wherein pressing the flanges down and toward each other to form an opening to the groove includes pressing the flanges down until they are generally flat at a crimp level below the initial surface level.
